(19) United States
(12) Patent Application Publication
(10) Pub. No.: US 2025/0028939 A1
(43) Pub. Date: Jan. 23, 2025

(54) Visualizing, Contextualizing and Evaluating Recommendations Generated Using Graph Neural Networks

(71) Applicant: Salesforce, Inc., San Francisco, CA (US)

(72) Inventors: Anamaria CRISAN, Seattle, WA (US); Lara THOMPSON, Vancouver (CA); Thomas MATINDE, Seattle, WA (US)

(21) Appl. No.: 18/429,336

(22) Filed: Jan. 31, 2024

Related U.S. Application Data
(60) Provisional application No. 63/527,583, filed on Jul. 19, 2023.

(51) Int. Cl. G06N 3/047

(52) U.S. Cl. CPC G06N 3/047

(57) ABSTRACT

A method generates data visualizations for interactive recommender systems for analytic assets. The method obtains recommendations to destination nodes for a source node of an input graph, which includes nodes including the source node and a destination node. Each node stores metadata for a respective analytic asset. The input graph encodes asset lineage that captures relationships between the analytic assets. The method also generates a data visualization for the recommendations. The data visualization includes (i) a summary of the recommendations, (ii) a comparison of the destination nodes, and (iii) a set of factors that contributed to one or more recommendations. The method also includes displaying the data visualization using a graphical user interface. The graphical user interface includes a data region that includes the summary, a recommendation overview region that includes the comparison, and a recommendation detail region that includes the set of factors.

### RELATED APPLICATION

This application claims priority to U.S. Provisional Application Ser. No. 63/527,583, filed Jul. 19, 2023, titled “Visualizing, Contextualizing, and Evaluating Graph Neural Networks Recommendations,” which is incorporated by reference herein in its entirety.

### TECHNICAL FIELD

The disclosed implementations relate generally to data visualizations, and more specifically to systems and methods for generating analytic asset recommendations using graph neural networks.

### BACKGROUND

Graph data is ubiquitous in the real world, but it is challenging to use graph data in conventional machine learning models. For example, traditional neural networks expect more structured and invariant inputs. Recent innovations in Graph Neural Networks (GNNs) and graph representation learning have shown considerable promise in overcoming these limitations and have grown in popularity amongst machine learning researchers. However, GNNs remain a black box, making it challenging to examine both how the model arrived at its conclusion and (in unsupervised settings) the accuracy or relevancy of the results. Visualization and machine learning researchers have begun to develop a suite of tools to examine GNN architectures to support model refinement, explain model decisions, and examine their results. However, existing visual tools for GNNs remain few and are limited to a small set of tasks.

A growing area of interest is the application of GNNs to content recommendation. Content recommendation is an area that has been actively explored for multiple decades and has recently benefited from an influx of more advanced machine learning approaches. Although the introduction of GNNs shows promise, it also introduces complexity toward interrogating and contextualizing recommendation results. Visual analytics tools that could mitigate some of this complexity are also challenging to develop because the overlapping visual and interaction encoding design space of GNNs and recommender systems is vast. Navigating this design space requires trade-offs between exploring the GNN architecture and exploring the validity of its recommendation results. Moreover, prior research on visualizing GNNs focuses on a different set of tasks, namely predictive performance and model tuning, which offers some, but ultimately limited, insight for recommendation tasks.

### SUMMARY

Accordingly, there is a need for systems and methods for generating analytic asset recommendations using graph neural networks. There is also a need for systems, methods and interfaces for visualizing, contextualizing and/or evaluating graph neural network recommendations. Some implementations provide a visual analytics tool that supports the interrogation of GNNs for content recommendation for data analysis. While recommendation systems can be applied to many areas, the majority concern e-commerce, advertising, or social applications. In some implementations, analytic asset content is stored as a graph that captures both the relationships and provenance of heterogeneous analytic content types, which includes databases, user-defined datasets, and prior analyses.

The techniques described herein can be used to examine whether a GNN approach can serve personalized recommendations in the flow of analysis, for example, recommending a pertinent dataset to an analyst end user. Systems according to the techniques described herein can be used to implement trade-offs between GNN and recommender system approaches to visual analysis. Some implementations provide a data and task abstraction for the application of GNNs to content recommendation for data analysis. Some implementations provide a platform that supports the interrogation of GNN results for recommendation tasks. Also described herein are example usage scenarios and an evaluation of the platform with machine learning and software engineers that examines design trade-offs.

According to some implementations, a method is provided for generating analytic asset recommendations using graph neural networks. The method is performed at a computing system having one or more processors and memory storing one or more programs configured for execution by the one or more processors. The method includes obtaining a data graph that includes a plurality of nodes. Each node stores metadata for a respective analytic asset of a plurality of analytic assets. The data graph encodes relationships between the plurality of analytic assets. The method also includes extracting a set of features for each node of the data graph. Each node may have different same features when compared to other nodes. The method also includes deriving corresponding node embeddings for two nodes of the data graph using a two-layer graph neural network based on the data graph and the set of features. The method also includes predicting a link between the two nodes of the data graph based on the corresponding node embeddings. The method also includes generating a recommendation for an analytic asset when the probability for the link is above a predetermined threshold.

In another aspect, a method is provided for generating data visualizations for interactive recommender systems for analytic assets. The method includes obtaining, from a recommender system that is trained to generate analytic asset recommendations, a plurality of recommendations to destination nodes for a source node of an input graph. The input graph includes a plurality of nodes including the source node and the destination node. Each node of the plurality of nodes stores metadata for a respective analytic asset of a plurality of analytic assets. The data graph encodes asset lineage that captures relationships between the plurality of analytic assets. The method also includes generating a data visualization for the plurality of recommendations. The data visualization includes (i) a summary of the plurality of recommendations to the destination nodes, (ii) a comparison of the destination nodes, and (iii) a set of factors that contributed to one or more recommendations of the plurality of recommendations. The method also includes displaying the data visualization using a graphical user interface. The graphical user interface includes a data region, a recommendation overview region and a recommendation detail region. The data region includes the summary of the plurality of recommendations to the destination nodes. The recommendation overview region includes the comparison of the destination nodes. The recommendation detail region includes the set of factors that contributed to the one or more recommendations of the plurality of recommendations.

In another aspect, an electronic device includes one or more processors, memory, a display, and one or more programs stored in the memory. The programs are configured for execution by the one or more processors and are configured to perform any of the methods described herein.

In another aspect, a non-transitory computer readable storage medium stores one or more programs configured for execution by a computing device having one or more processors, memory, and a display. The one or more programs are configured to perform any of the methods described herein.

Thus methods, systems, and graphical user interfaces are disclosed that allow users to efficiently explore analytic assets within a data visualization application.

Both the foregoing general description and the following detailed description are exemplary and explanatory and are intended to provide further explanation of the invention as claimed.

### BRIEF DESCRIPTION OF THE DRAWINGS

FIG. 1 shows an example user interface for visualizing, contextualizing and/or evaluating recommendations from graph neural networks, according to some implementations.

FIG. 2 shows an example two-staged graph neural network pipeline for analytic asset recommendations, according to some implementations.

FIG. 3 shows a simple representation of the types of nodes that may appear in an input graph of analytic assets for recommendation, according to some implementations.

FIG. 4 shows an example user interface for scoring the quality of a recommendation in a table view of a data panel, according to some implementations.

FIG. 5 shows an example user interface for interrogating the relationship between recommendation probability and different graph attributes and node features, according to some implementations.

FIG. 6 shows an example wrapped two-dimensional array view used to visualize a recommendation as a row set, according to some implementations.

FIG. 7 shows an example embedding projection view, according to some implementations.

FIG. 8 shows examples of view coordination, according to some implementations.

FIG. 9 shows an overview of an example usage scenario, according to some implementations.

FIG. 10 shows an overview of another example usage scenario, according to some implementations.

FIG. 11 is a block diagram of an example computing device for generating and/or visualizing recommendations for data analytic assets, according to some implementations.

FIG. 12 is a flowchart of an example method for generating analytic asset recommendations using graph neural networks, according to some implementations.

FIG. 13 is a flowchart of an example method for generating data visualizations for interactive recommender systems for analytic assets, according to some implementations.

For a better understanding of the aforementioned systems, methods, and graphical user interfaces, as well as additional systems, methods, and graphical user interfaces that provide data visualization analytics, reference should be made to the Description of Implementations below, in conjunction with the following drawings in which like reference numerals refer to corresponding parts throughout the figures.

Reference will now be made to implementations, examples of which are illustrated in the accompanying drawings. In the following description, numerous specific details are set forth in order to provide a thorough understanding of the present invention. However, it will be apparent to one of ordinary skill in the art that the present invention may be practiced without requiring these specific details.

### DESCRIPTION OF IMPLEMENTATIONS

Content recommendation systems use a variety of techniques for serving relative content to end-users. Recently, graph neural networks (GNNs) have been used as a possible machine learning solution to content recommendation in various domains, such as chemo-informatics, transportation, and e-commerce, among others. A brief overview of GNNs is provided herein in the context of visual analysis. A summary of goals for recommending analytic assets is also described herein.

### Graph Neural Networks (GNNs)

Common neural networks cannot take graph data as input without significant transformation and loss of information. This is because, unlike other forms of data (e.g., image, text, audio, tabular), graphs have a more variable structure that can make them more challenging to model. While there exists analytic alternatives of neural network-based approaches for graphs, these too are limited and do not fully exploit the combined properties of a graph topology and its input features. Graph neural networks (GNNs) were developed to accommodate graph input data and its unique properties. Graph convolutional networks and their derivatives are used as examples for the sake of description, but the techniques described herein apply to other instances of GNNs. GNNs can be used for graph, node, and link (edge) level tasks. For example, GNNs can classify the toxicity of chemical structures (graph task), whether two friends belong to the same clique (node task), or predict if a person will like a specific book (edge task). Content recommendation can be thought of as an edge task, or more specifically, a link prediction task between two nodes (content items) in an input graph. There are many possible ways to address this task with GNNs.

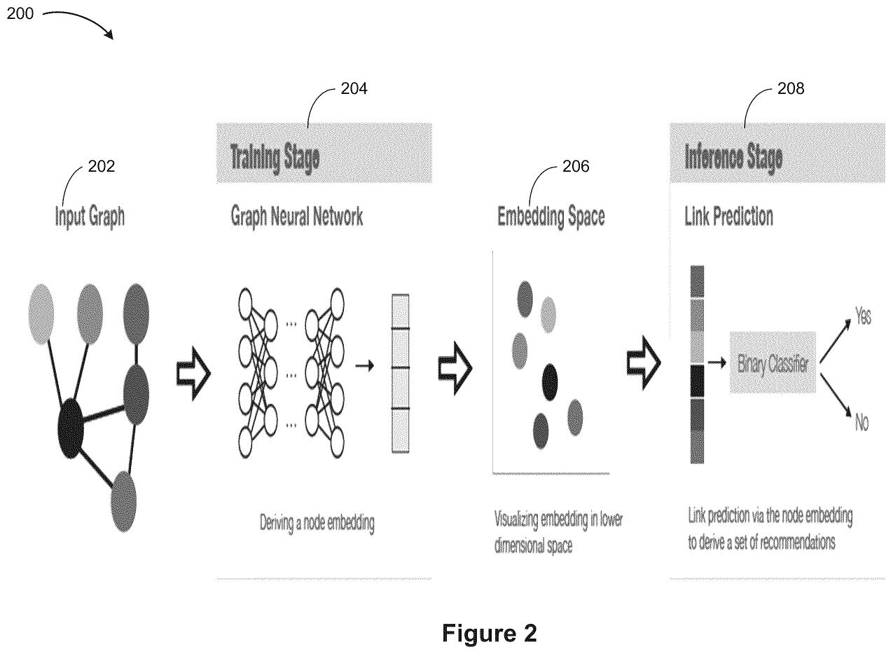

Described herein is an example method that uses a two staged GNN pipeline, an example of which is shown in FIG. 2. In the initial training phase, node features and graph properties for an input graph 202 are used to compute (204) an embedding representation 206. Features can also be ascribed to edges, but this scenario is not evaluated in great detail here. To derive the embedding, in some implementations, information is aggregated from neighboring nodes of the input graphs, an operation that is sometimes referred to as message passing. Each convolution layer in the GNN aggregates information from more distant neighbors. For example, a single convolution layer GNN aggregates information from the nodes a single hop away, and two layers corresponds to two hops. A subsequent inference phase 208 uses the node embedding from training for a variety of downstream graph, node, or edge level tasks. For a link prediction tasks, node embeddings are concatenated and then passed to a binary classifier that produces a probability. This probability can be used to establish a threshold for serving a recommendation to an end-user. Node embeddings can also be used for non-graph tasks, such as surrogate features for other machine learning models.

### Domain Goals and Collaboration Context

The techniques described herein may be used for content recommendation, such as analytic asset recommendation. Analytic assets include databases, user defined datasets, and prior analyses, which are stored large repositories of heterogeneous data assets and their associated metadata. Discovering relevant content for data analysis within such a large and heterogeneous collection of data remains a complex and unsolved problem with many different possible solutions. Machine learning and software engineers can use the GNN-based techniques described herein for recommending content to an analyst.

A goal for the proposed techniques is to recommend content to an analyst end-user in order to support asset discovery, speed up the analysis process, and avoid possible duplication of analytic efforts. The analyst end-user seeks to discover and use data from a large heterogeneous data store, which is a different goal from machine learning and software engineers. Collaborative filtering based approaches, using product telemetry data to make recommendations can be used in addition to the techniques described herein. Another goal for the proposed techniques is to help understand the GNN's recommendations and to help users to modify GNN as needed. The visual analytics tool described herein can help machine learning and software engineers interactively explore recommendations and tag relevant insights. Some implementations do not modify the GNN architecture directly, but can be used to export relevant insights so that machine learning engineers can use them within already established Python-based data science or machine learning (DS/ML) workflows.

The input graph, which is the graph data to be analyzed by the GNN, and the dataflow graph of a GNN, or neural network more generally, are two different graphs.

### GNN Visualization

Conventional techniques for visualizing GNNs focus on analyzing the input graph together with quantitative metrics of its performance, typically on prediction tasks. Many of these systems derive an intermediary graph representation to support the assessment of what the GNN has learned. Some systems contrast visualizations of the input graphs global topology against the GNN-derived embedding (or latent space), enabling the end-user to explore these relationships with multiple coordinated views. Embeddings are visualized using dimensionality reduction techniques, such as, Uniform Manifold Approximation and Projection (UMAP) and t-distributed Stochastic Neighbor Embedding (t-SNE). While input graphs can benefit from existing techniques to visualize and interact with multivariate network graphs, these methods have not been widely used in GNN visualization systems. Node features are also visualized in varying ways and presented concurrently with the input graph and embedding. Some systems also visualize node specific features and an intermediary k-hop topology representation, but vary in their specific treatment of both. While some conventional systems (e.g., CorGIE, GNNLens, and GEMVis) are largely aimed at supporting error analysis, BiaScope focuses more on identifying possible biases in GNN learning. A different set of visual design patterns is presented in the system described herein. The system uses a visualization of the GNN embedding to drive interactions with specific graph paths. Unlike prior systems, this system considers the heterogeneity of the GNN's nodes and leverages these properties to create path explanations supported by a specific view. Collectively, these systems are intended for stakeholders with machine learning or artificial intelligence expertise intending to refine a GNN model except for systems that prioritize scientific domain experts.

The machine learning community has developed techniques for evaluating, explaining, and visualizing GNN behavior. For example, some systems use visualizations of the overall input subgraph to show the influence of specific nodes and neighborhoods on a GNN's prediction. They also visualize the features of individual nodes. Some systems optimize to generate and visualize explanations. As GNN research continues, additional encoding and interaction techniques are likely to be developed, either independently of, or with collaboration with, the visualization research community.

The techniques described herein draw on emerging design patterns. Described herein are also applications of the techniques to recommendation tasks and for exploring alternative designs.

### Visualizations for Neural Networks

Some implementations provide techniques for visualizing neural networks. Visual analytics for Deep Neural Networks (DNNs) can be used as a set of interrogative questions that are then tied to specific visual encodings and their uses. While DNNs vary in their applications and architectures, there are overlaps with GNNs, particularly with respect to visualization of embedding and latent spaces, dataflow graphs, and features. Neural network visualization techniques and tools are typically rooted in more general research concerning visual analytics for machine learning. Visual analytic methods for neural networks may be used for GNN visualization for GNN-based recommendations.

### Visualization for Interactive Recommender Systems

User interfaces for recommender systems typically have two purposes: (a) eliciting information from end-users via interactions, and (b) presenting the results of recommendations for end-users to explore. Visualizations for recommender systems play an important role in explaining recommendations, allowing end-users to fine-tune and control their preferences, and take next actions. Some implementations visualize recommendations as a node-link diagram and invite user interaction to interrogate the results. Some implementations use a combination of node-link diagrams, clusters, and Venn diagrams, to visualize the diversity of recommendations and overlap of preference. Some implementations also provide widgets allowing end-users to weight different factors in recommendation and visualize their effects. Some implementations use different techniques for aligning recommendations with human judgements in content-based recommendations of data assets and presents the results as a visual gallery. Some systems visualize individual user recommendations through radar or scatter plots of preferences.

The techniques described herein can be applied to domains and applications other than the examples provided for illustration.

### Data and Model Overview

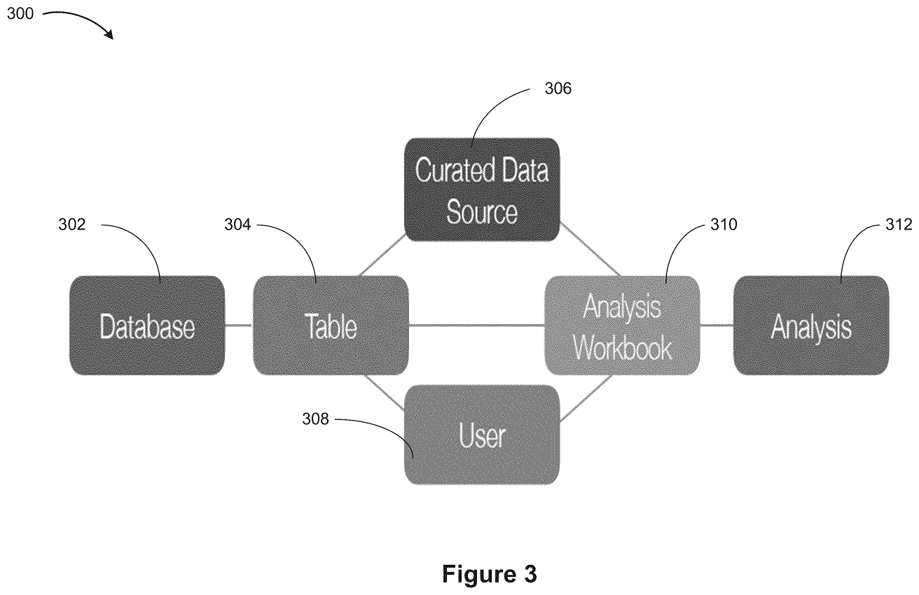

Described herein is an overview of the input data graph sometimes referred to as an input graph or a data graph) and the GNNs that are used to generate analytic asset recommendations and for visualization, according to some implementations. FIG. 3 shows an example representation of the asset types that may appear in an input graph 300 of analytic assets for recommendation, according to some implementations. Shown are the types of analytic assets that are recommended, including user information, as well as the lineage relationships (shown as lines or as edges, sometimes referred to as edges) between assets and (when applicable) users. Example assets include databases 302, tables 304, curated data sources 306, analysis workbooks 310, and/or analyses 312, which may be represented as separate nodes. Users 308 may be represented as a separate node in the input graph. Each node may represent individual assets or a group of assets belonging to that category or type. For example, a database asset 302 may represent one or more databases that share a similar property (e.g., atomicity, consistency, attributes, fields, data types, values). Typically there are multiple instances of each asset type (e.g., many users 308 and many tables 304).

### Data Acquisition

Machine learning engineers capture end-user analysis through a data graph. The graph stores metadata for different assets, which includes the asset type (e.g., databases, tables, and analysis workbooks), asset authors (sometimes referred to as users, and including end-user details), and creation data, among other things. The graph also encodes the asset lineage that captures the relationships between assets. For example, a dataset is a type of content that can form a lineage relationship with one or more analysis workbooks. Other data sources can include telemetry and usage data that identify when and by whom analytic assets are created and viewed, respectively. The combination of these two data sources can be used to produce personalized recommendations for analyst end-users. However, the full data graph can contain more data than is typically useful for content recommendation. Some implementations derive a smaller graph that contains only user data and a limited set of analytic assets, an example of which is shown in FIG. 3. Data graphs may include a large number of nodes and edges (e.g., 211,515 nodes and 459,150 edges). The input graph in FIG. 3 shows only one instance of each analytic asset type.

### GNN Model Training and Inference

Some implementations use a GNN developed using previously described two-stage pipeline (e.g., as in FIG. 2). Ahead of training the GNN model, some implementations derive a set of features for each node. These features included asset type, community clustering, centrality, and node degree. GNNs can treat node features as homogeneous (i.e., all nodes have the same features) or heterogeneously (i.e., sets of nodes have features distinct from others). For the sake of illustration, node features described herein are treated homogeneously.

The input graph and set of node features are then used to train a two-layer GNN. Since the maximum path length between any two nodes in the input graph is just 12 hops, it is not necessary to train a deeper GNN. In fact, doing so could lead to over smoothing. Each layer is a GraphSAGE convolution, as opposed to a standard graph convolution layer, because it generalizes better to unseen data and unsupervised applications. The GNN is batch trained over ten epochs. Each batch samples only a small portion of a node's neighborhood: one of its direct neighbors and one random node. The training phase produces a node embedding.

### Data Abstraction

In the inference stage, the derived node embedding is used to perform link prediction between any two nodes in the graph. Two nodes can constitute any analytic asset type. For example, a link can be predicted between a user node and an analysis node, or an analysis workbook node and a database. For simplicity, an initial node of interest is referred to as the source node and recommendations are derived for one or more destination nodes. The link prediction step also produces a probability that any two nodes are connected. Probabilities >0.5 may be taken as a threshold to serve a recommendation to an end-user. Recommendations can be rank ordered by probability and according to analytic asset type.

Understanding the quality of the GNN's recommendations is complex. There is no ground truth data beyond the immediate properties of the graph, but it is possible to make useful assessments based on the these properties. For example, nodes that are directly connected by an edge should have high link prediction probabilities, but it is not clear that those which are more distantly connected, or not connected at all, should have lower probabilities. For example, two distant nodes may belong to the same community, disconnected nodes may share common features. Thus, relying primarily on the topological structure of the input graph as a proxy of quality can limit assessments of the GNN's recommendations. To assess the quality of recommendations, machine learning engineers and software engineers may analyze the recommendations and apply their subjective knowledge about the input graph.

Typical data used is of the following types:
A multivariate network that contains derived feature attributes for each node. Importantly, each node in the network belongs to an asset type (e.g., input graph shown in FIG. 3) and edges are connections between one or more asset types.
A dataflow graph that describes the architecture of the GNN and the computations used to train it.
An embedding that maps the nodes and structure of the input graph into a lower-dimensional vector representation.
A tabular dataset comprising the features of nodes and their probability of being linked to a source node.

Some implementations consider these different abstract data types collectively with the design space crossovers between GNNs and recommender systems.

### Task Abstraction

Visual analysis goals include contextualization of recommendation results and qualitative assessment of their validity. These visual analysis goals are broken down into the following tasks:
T1. Summarize the GNN's recommendation results for a given input node, including its relationship to other nodes (e.g., correlations and outliers), features, and prediction probabilities.
T2. Compare recommendations for a single node. For example, comparing recommendations according to their distance from the node of interest.
T3. Contextualize the results for a single input node by understanding the types of assets that were recommended, the distribution of their probabilities, and the similarities of the features.
T4. Validate the GNN's results by applying domain knowledge to accept or reject the recommendations.

These tasks prioritize understanding the results of a single node and its full complement of recommendations. Some implementations allow users to examine a single node at a time together with the subset of its recommendations. Collaborators often had specific questions pertinent to specific nodes and visualizing the full spectrum of nodes and links (existing and predicted) was less relevant.

### Example User Interfaces for GNN Visualization

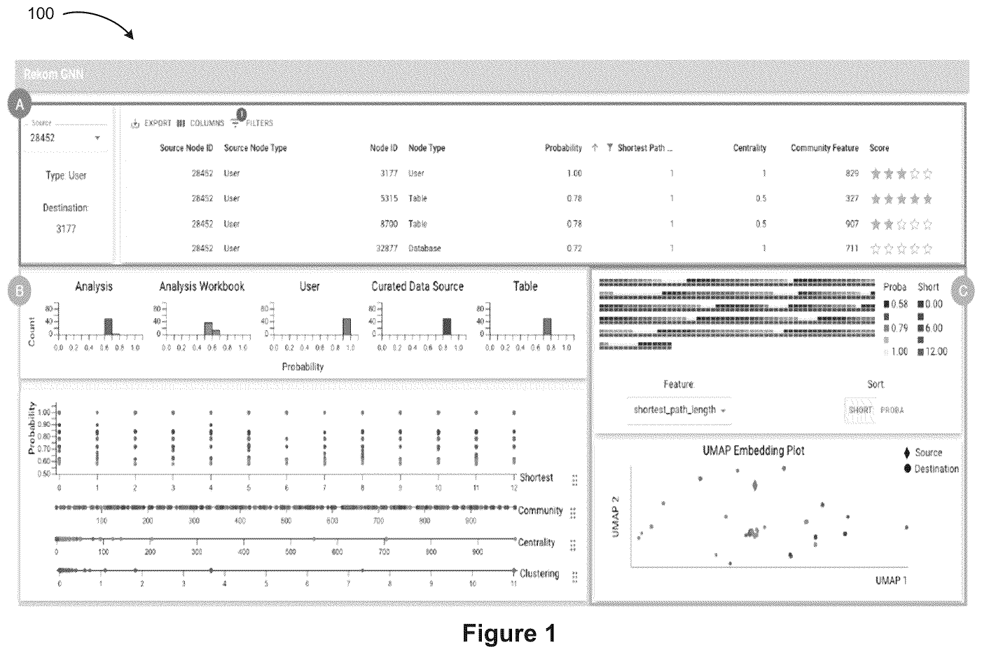

FIG. 1 shows an example user interface 100 for visualizing, contextualizing and/or evaluating recommendations from graph neural networks, according to some implementations. Some implementations provide an interface that includes a data panel (A), a recommendation overview panel (B), and a recommendation detail panel (C). Users can use the interface to interrogate GNN results. The data panel (A) allows users to examine a plain view of recommended nodes and highlight recommendations of interest across the system. Users can score and export the quality of the recommendations within the data panel for further external refinement of the GNN. The recommendation overview panel (B) allows users to compare prediction probabilities across different node types and/or attributes of individual nodes and the input graph. The recommendation detail panel (C) allows users to further contextualize the relationship between recommendations, prediction probabilities, and different features in relation to other nodes.

Given some source node in the input graph, the data panel allows users to summarize (T1) recommendations to other destination nodes, including the prediction probability, and to record a qualitative assessment of the prediction quality, according to some implementations. In some implementations, features and other properties of destination nodes are shown to help users make their assessments. Users also often have questions about specific source-destination node combinations, for example, if they feel strongly that some data source (destination node) should be recommended to an analyst because they are using a related dataset in their present analysis (source node). Some implementations allow users to filter the table to a destination node of interest can validate (T4) their hypothesis.

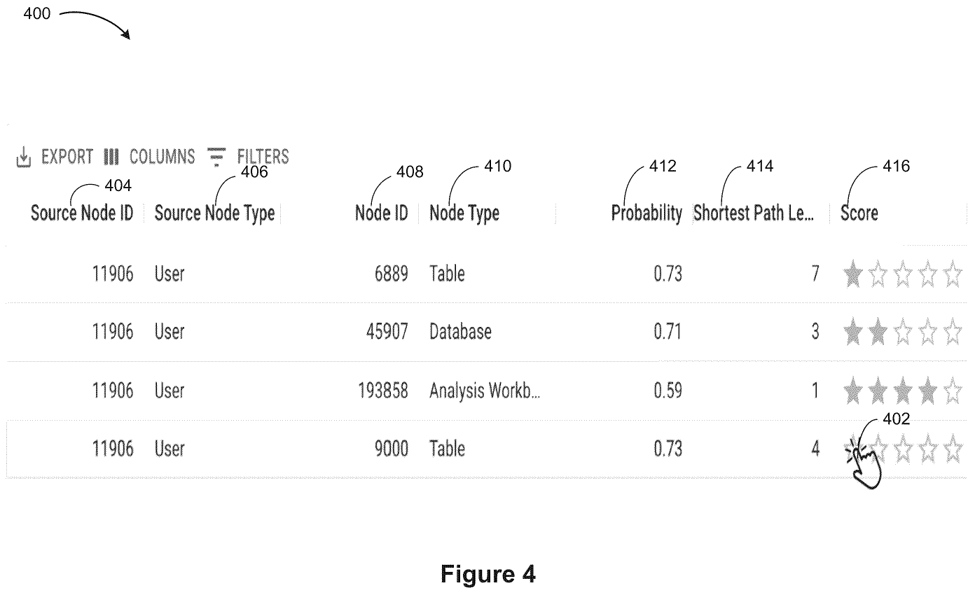

FIG. 4 shows an example user interface 400 for scoring the quality of a recommendation in a table view of a data panel, according to some implementations. Users can score (402) the quality of a recommendation in the table view of the data panel. In this example, the table view includes columns for a source node identifier 404, a source node type 406, a node identifier 408, a node type 410, probability 412, length of shortest path 414 between source node and node, and a score 416. In some implementations, these annotations are retained and can be exported for further analysis in an existing DS/ML workflow.

Data Panel. In some implementations, the data panel includes a node selection widget and a table view. The node selection widget enables the user to select a source node from the input graph (via its node identifier) and displays some of its basic properties. A table panel displays the destination nodes of the predicted links. As the user examines the GNN's recommendations through the three components, they can log their qualitative assessments in a table view. By allowing users to annotate recommendations, they can bring their subjective expertise to bear on the quality of the results and not rely solely on quantitative metrics. These annotations are stored and can be modified at any point, they can also be exported as a CSV to Python, where machine learning engineers and software engineers can further explore them. When engineers update the GNN, they can import the results for further analysis and refinement. Importantly, this type of import-export integration allows easier incorporation into existing, and ever changing, workflows.

Recommendation Overview Panel. While the data panel provides a summary, the recommendation overview panel makes it easier to compare (T2) recommended nodes simultaneously. In some implementations, the recommendations are shown to users along with their predictive probabilities and node properties. Users can visually examine and interact in order to develop insights into how the GNN may be making recommendations, and make assessments of the result quality. For example, users may wish to consider the relationship between the distributions of prediction probabilities and the path length between the source nodes and possible destination nodes. They might be intrigued to find nodes with high probabilities that are distant in the input graph and wish to examine this further. Notably, this kind of exploration does not require the visual of the input graph directly, but rather its derivative properties.

In some implementations, the recommendation overview comprises a probability distribution panel, broken down by node type, and a recommendation attribute panel that provides further details of the relationship between the probabilities and attributes from the input graph. The recommendation probability coordinates the views in the two panels, helping the end user compare (T2) recommendations.

Recommendation Detail Panel. Users can drill deeper into a specific set of recommendations to further contextualize (T3) individual factors that contributed to the GNN's recommendation and compare (T2) to similar nodes in the embedding space. The views of the detail panel are complementary to both the overview and data panels, but offer both an alternative and deeper level of granularity to examine recommendations.

Some systems are implemented in JavaScript using React.js, D3, and visx. The GNN model is implemented in Python using Pytorch and the PyG libraries. Graph data are stored in a data catalog from which a simpler subgraph is derived and subsequently stored and analyzed entirely using NetworkX.

### Example GUI Design

Some implementations use various design choices for the visual encodings and interaction techniques that support the panels of the interface. The design choices may be based on data and task abstractions and with respect to trade-offs between the GNN and recommender system design spaces.

### Example Visual Encodings

Some implementations provide different visual encoding design choices for the panels of the interface components. Some implementations use the size of the input graph as a design constraint for the view. The size makes it challenging to display all of recommendations for a source node and requires aggregating or sampling the data. Some implementations use a stratified sampling approach that draws a representative sample from across the range of recommendation probabilities. In some implementations, repeated draws yield new recommendations to interrogate.

### Example Data Panel

The data panel allows users to inspect the underlying tabular dataset of the GNN's recommendations. Through simple interactions they can choose the node features to inspect-ordering, or filtering the rows by the values of different columns, and even removing columns they might not be interested in exploring. As previously described, this view also allows users to score the recommendation quality. Finally, the table view of the data panel is also consistent with how machine learning engineers and software engineers regularly interact with their data. As such, the table view is an important anchor in their analysis ahead of proceeding further with a visual analysis.

In some implementations, the table view contains information not only about the source and destination nodes, but also derived properties of the input graph, such as the shortest path between two nodes and communities within the graph. Some implementations refer to node features as existing (e.g., asset type) or derived (e.g., centrality) attributes for a single node; graph attributes are derived from the relationship between multiple nodes (e.g., shortest path, community). The design choice of having node features and graph attributes in a table is a departure from prior systems that visualize GNNs and that visualize the input graph or a derived intermediary graph (e.g., k-hop topology). This is further described below.

### Example Recommendation Overview Panel

In some implementations, the overview component visualizes the recommendation distributions of probabilities together with node features and input graph attributes. With this set of complementary views, an analyst can explore the univariate and bivariate relationships between the recommendation probabilities and the different topological attributes, building up an intuition toward how the input node is related to these recommendations. It is challenging to explore these kinds of insights in prior systems that visualized GNNs. For example, while some conventional systems also visualize node features, they do so primarily to identify influential nodes for their prediction tasks and less so to compare the predictions a single GNN makes. Such systems instead focus on comparing predictions between different GNN implementations. Yet other conventional systems prioritize the relationships between the input graph topology, embedding, and feature space. While such systems do enable some comparison of features, these are based on derived distances rather than the node's features. On the other hand, the interfaces described herein enable these comparisons through the probability histogram and multi-axis scatter plot views, according to some implementations.

### Example View Layout and Coordination

According to some implementations, in the probability histograms view, analysts can observe the recommendation probability distributions according to the six asset types (e.g., FIG. 3) described above. These asset types are not fixed, and these categories can be easily modified to different types and quantities of analytic assets and domains (e.g., e-commerce applications). The probability distribution allows users to evaluate the model's confidence with respect to recommending an asset type. Moreover, this comparison of distribution across asset types enables users to triage potential issues with asset types. For example, if the GNN recommends all database assets with the same probability, it may be an indicator that the features of the nodes for database assets are not informative. Instead of, or in addition to, using histograms to visualize feature distributions, some implementations prioritize the recommendation probabilities specifically because of their importance to users' understanding of the GNNs results.

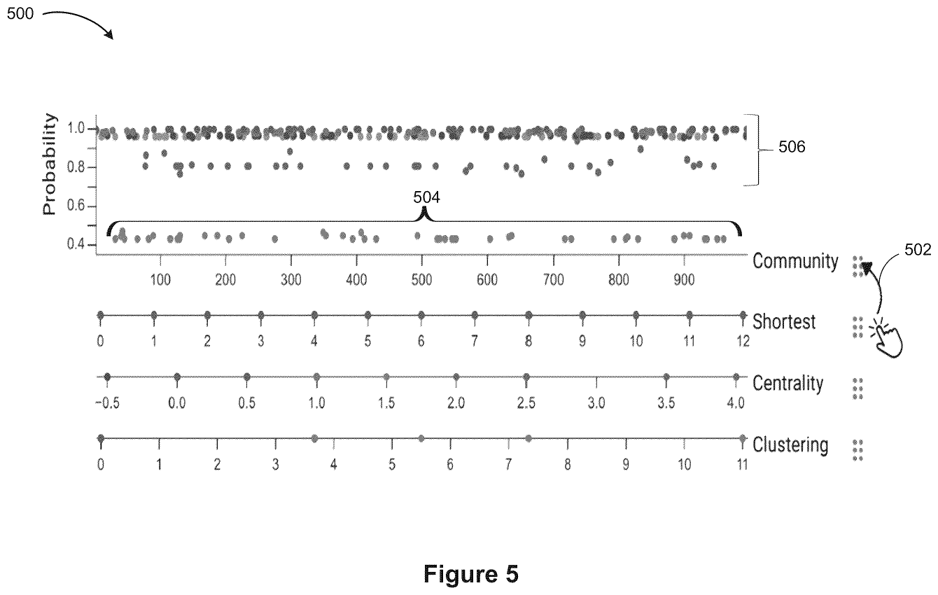

FIG. 5 shows an example user interface 500 for interrogating the relationship between recommendation probability and different graph attributes and node features, according to some implementations. Users can drag-and-drop the x-axis to interrogate the relationship between the recommendation probability and different graph attributes and node features. This example shows a multi-axis scatter plot that shows the bivariate relationships between the recommendation probabilities and different node features and graph attributes. While the y-axis remains fixed, the x-axis can be changed through a drag-and-drop interaction (502). As the x-axis changes, it is possible to visually assess the distribution of probabilities across different asset types as well as features and attributes. In the example shown in FIG. 5, it is possible to see that regardless of the community they occur in, user nodes 504 are consistently predicted with lower probabilities compared to other asset types 506. By shifting the axis to different features, users can establish factors that might be influencing these results. Conventional systems use feature matrices or feature strips to show similar insights. The interactive multi-axis scatter plot is advantageous over the more static feature matrices, because it is easier to see and interrogate bivariate relationships; dynamically changing the x-axis amounted to probing the GNN's results in order to surface insights that could be further contextualized or validated.

### Example Recommendation Detail Panel

In some implementations, the detail component is comprised of two adjacent views: a wrapped two-dimensional array and embedding projection. These views help the user to inspect recommendations they selected in the table or overview components and analyze them in more detail. These views provide a complementary perspective to those in overview panel by recasting some of the data as different visual encoding. The redundancy that results from this design choice is intended to support the user to further compare (T2) and contextualize (T3) recommendations.

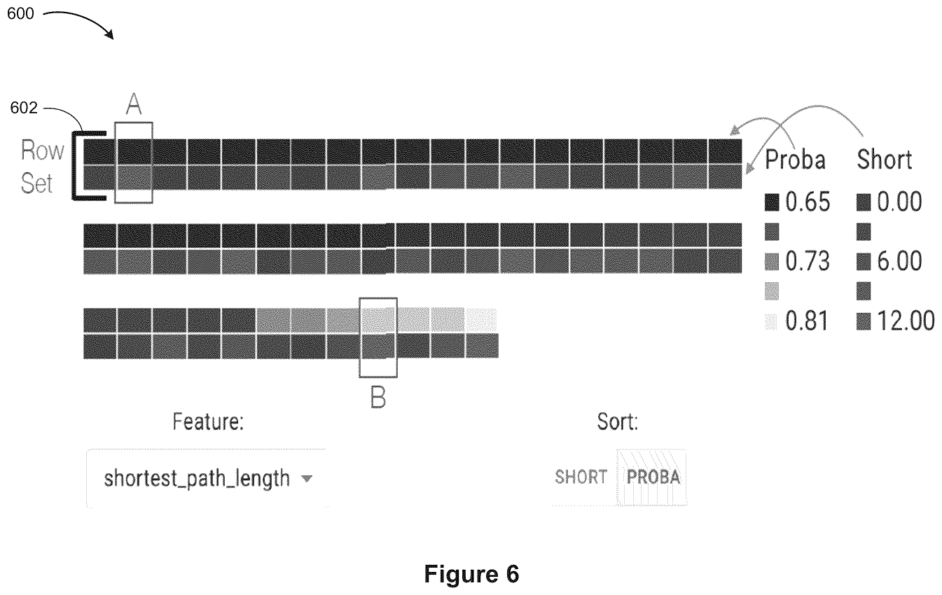

FIG. 6 shows an example wrapped two-dimensional array view 600 used to visualize a recommendation as a row set, according to some implementations. The wrapped 2-D array view is comparable to the feature matrices and stripes as well as the multi-axis scatter plot. However, instead of showing the probability against multiple features and attributes, the wrapped two-dimensional array displays the probability and feature as a row set. Each row set 602 corresponds to one recommendation and comprises a recommendation probability (top row) and a feature (bottom row). This view offers a complementary perspective to the multi-axis scatter plot. Two examples (row sets A and B) are highlighted where recommendations have roughly the same path length, but vastly different prediction probabilities. Hovering over a specific row set emphasizes the recommendation in other views. The row sets have similar path lengths but different recommendation probabilities. This example shows a filtered view of the highest probabilities. Two divergent color palettes are used to compare the probabilities and features, with darker colors of both scales representing lower values (e.g., lower probability, shorter path length). This design choice makes it easier to identify interesting bivariate relationships.

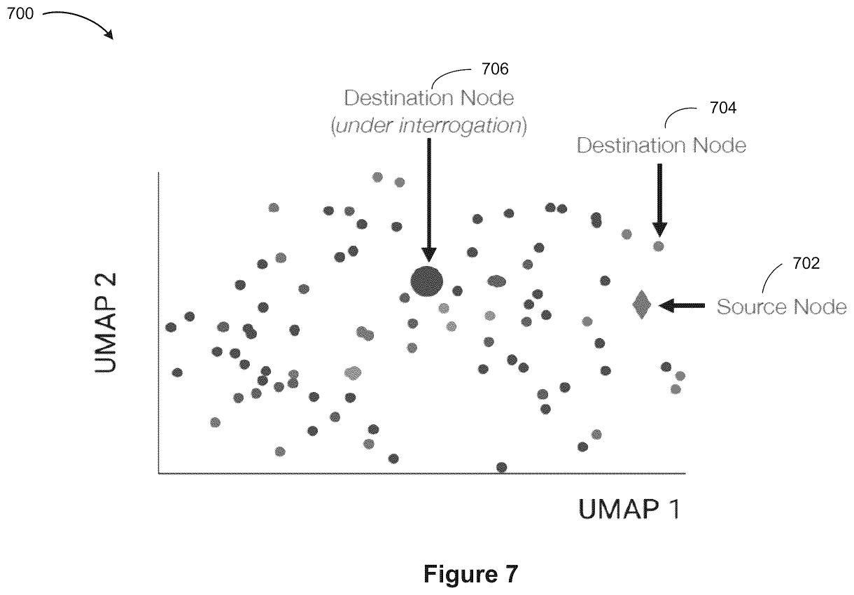

FIG. 7 shows an example embedding projection view 700, according to some implementations. The view shows source and destination nodes. Larger destination nodes are those under interrogation in other views and are interactively linked via hovering interactions. The embedding projection view is useful for visualizing GNNs as well as other neural networks. This view projects the node embeddings produced by a GNN (an example of which is shown in FIG. 2) into a two dimensional space using a Uniform Manifold Approximation and Projection (UMAP). Some implementations use shape to differentiate between source nodes 702 (shown by shape.) and destination nodes 704 (shown by shape.). In some implementations, the points are also colored according to asset type. While other views highlight univariate distributions or bivariate relationships of different features with the probability, the embedding view represents a multivariate summary of the data. Users can further contextualize recommendations by using the distance between points as a proxy for the similarity for the nodes. This too can be used to triage the recommendations of the GNN. For example, if the source nodes is a database and the proximal other database destination nodes this could also be a signal of an uninformative feature space for the nodes. The embedding projection could also be used to identify outliers (e.g., destination node 706), which may be more difficult to assess in other views.

### Example View Layout and Coordination

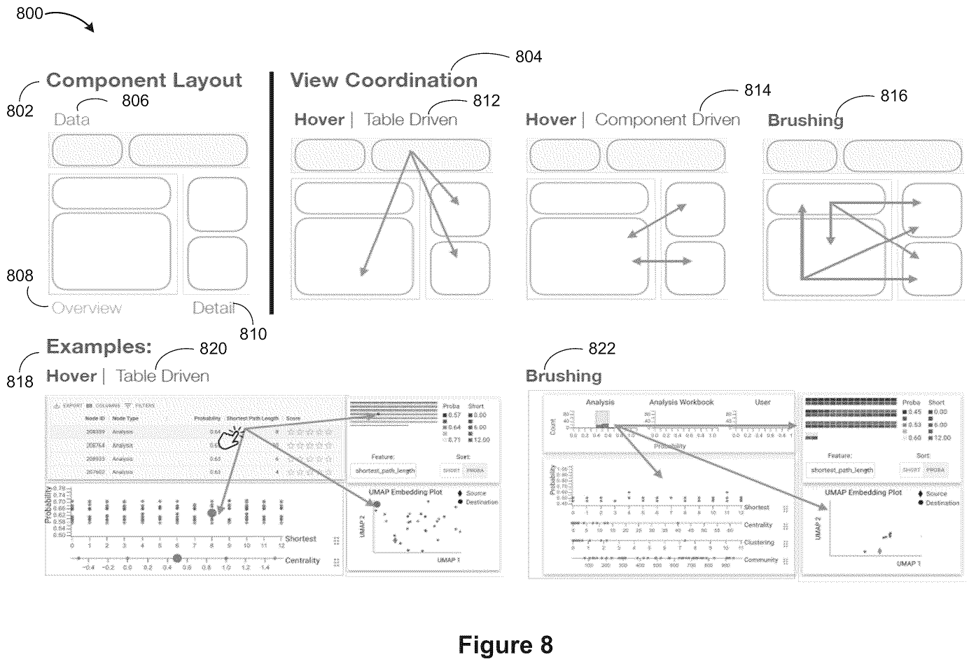

FIG. 8 shows examples of view coordination 800, according to some implementations. For an example component layout 802 (a layout of data panel 806, overview panel 808 and detail panel 810), view coordination 804 may be achieved through hovering interactions (e.g., table driven hover interactions 812, component driven hover interactions 810, and/or brushing interactions 816) and has effects across panels. In some implementations, views are grouped within their respective table, overview, and detail components and are linked through hovering and brushing interactions. These interactions serve to emphasize and filter nodes, respectively, across views. Hover interactions can be initiated either from the table or through different components to visually emphasize individual destination nodes from a source node. In some implementations, hover interactions that are initiated from the table have effects on views within other panels. In some implementations, interactions initiated from components do not act to filter the table. The consistency in the table view anchors the user's visual analysis experience, modifying it in response to panel interactions was disorienting and undesirable. Specific examples 818 are provided below, for table driven hover interactions 818 and brushing interactions 822.

In some implementations, in the scatter plot and embedding views, nodes are visually emphasized by changing their size relative to the others in the plot. In some implementations, changing both the size and opacity of nodes causes highlighting the destination node of interest. The size of the dataset may result in a varied opacity across the plots because some regions were more dense (i.e., contained more data points) than others. Accordingly, some implementations keep the opacity consistent and modify only the point size so that fewer aspects of the plot were changed. The consistency in the views in response to hover interactions makes it easier for users to identify the emphasized node.

In some implementations, brushing cross-filters the data displayed in the linked views. This interaction can be initiated within the probability histogram and multi-axis scatterplot views and enables users to filter to specific node types within a probability range of interest. For example, a user may want to interrogate database assets that receive low probabilities in the GNN's recommendations to assess what factors contribute to these results.

Conventional visual analytics tools and recommender systems feature the input graph as a central component. Instead of the input graph, some implementations display derived properties of the graph, such as communities and path lengths. The input graph is not always helpful for making validity assessments of the GNN's recommendations. For example, if a user observes a high recommendation probability, they could examine the input graph to see how distant two nodes are. This action is equivalent to mentally calculating the shortest path between two nodes. Some implementations perform this calculation for the users and display its result. Additionally, the size of the input graph may make it undesirable to examine even if it was included.

Some implementations display embedding projection and alternative ways to visualize features, instead of, or in addition to, displaying, a data flow graph for a model architecture. These visualizations help machine learning engineers perform refinement tasks within their existing workflow.

In some implementations, the link prediction probability, or recommendation probability, help sample the data as well as link and coordinates views. For the more general recommendation tasks that drives domain goals, the probability is a useful mechanism by which analysts can view recommendations. Some implementations allow users to provide feedback to recommender systems on the quality of recommendations, via the data panel.

The size of input graph can necessitate a trade-off between visually aggregating the data and sampling it. Aggregating introduces a coarseness to the visual display that can obscure trends and outliers that are of interest to users. For graph data in particular, it can be challenging to condense a complex graph topology, and even though there exists techniques to visualize dense graphs, it is difficult to interpret them. Sampling allows users to observe individual data points, but also omits much of the data. Compared to aggregation, sampling, and if necessary repeated sampling, provides an appropriate level of granularity to examine the GNN's recommendation results. Some implementations forego displaying the input graph and prioritize the recommendation probability, and sub sample the full data accurately.

### Example Usage Scenarios

Example usage scenarios are described herein, according to some implementations. The examples illustrate how domain users can realize their tasks using the tool and/or techniques described herein. Additionally, feedback was gathered across multiple user sessions, for which four analysts evaluated the efficacy and usability of the system. Highlights and experiences were captured using the system during sessions with machine learning engineers and software engineers using a heterogeneous graph dataset.

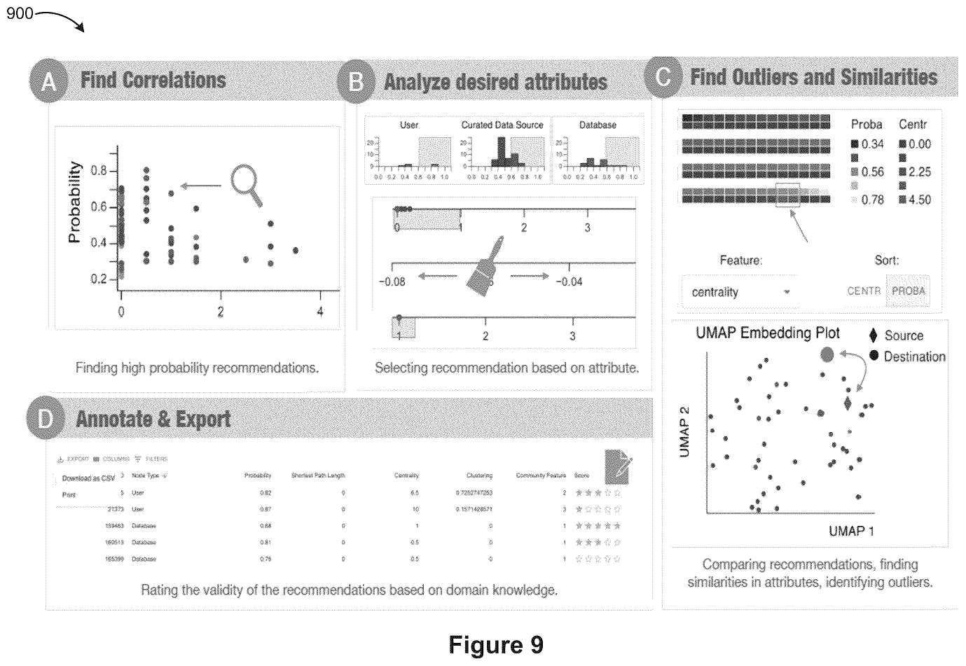

FIG. 9 shows an overview of an example usage scenario 900, according to some implementations. This scenario corresponds to outliers and validation. Suppose Sarah is a machine learning engineer who implemented a graph neural network to make recommendations of different assets for a set of users. In this scenario, she is looking for outliers and aspects that differ from her experience with this data. She starts by selecting a source node in a data panel. Sarah begins by looking for ill-behaved examples, such as recommendations connected to the source node but with low probability (e.g., step A, FIG. 9; find correlations, find high probability recommendations). She brushes over the parallel axis corresponding to the shortest path length equal to 1 (e.g., she selects the recommended nodes that are one hop away from the source node; step B, FIG. 9; analyze desired attributes, select recommendations based on attribute). She observes a couple of things: 1) the recommendation with the highest probability is a user node, and it is also close to the input node in the embedding projection view; and 2) the majority of the nodes have a low centrality except one analysis node, an outlier that is easy to identify in the wrapped two-dimensional array in the recommendation detail panel (e.g., step C, FIG. 9; find outliers and similarities, compare recommendations, find similarities in attributes, identify outliers). Sarah rates the recommendation (e.g., step D, FIG. 9; annotate and export, rate the validity of the recommendations based on domain knowledge) in 1) with a five out of five rating since the model learned the existing link in the graph, and the recommendations in 2) with one star out of five, meaning that she does not trust it since it presents a centrality value that is not common among the highly recommended nodes.

In this case, the recommendations with the highest probability are users, curated data sources, and databases, so she brushes over the probability histograms corresponding to these node types and probability greater than 0.6. Even if these nodes are connected to the input node topologically, they seem to be vastly different in terms of node attributes, as the analyst observes in the embedding projection view. Sarah rates these nodes with neutral score (three stars out of five).

Sarah continues her search for ill-behaved cases by returning to the multi-axis scatterplot view, dragging the centrality axis into focus, and observing at least three outliers with the lowest probability among all recommendations. She brushes over these recommendations and sees that they are all analysis workbook nodes, have clustering equal to zero, and are all connected through a path of length equal to or greater than five. Again, she annotates these cases in the table view, this time with a low rating (two out of five stars).

After Sarah annotated all the predictions that need further external analysis and inspection, she exports in CSV format and imports them into Python. There, she performs changes to the input graph and to the GNN architecture as necessary and retrains the GNN, and regenerates the recommendations for another iteration of recommendation analysis.

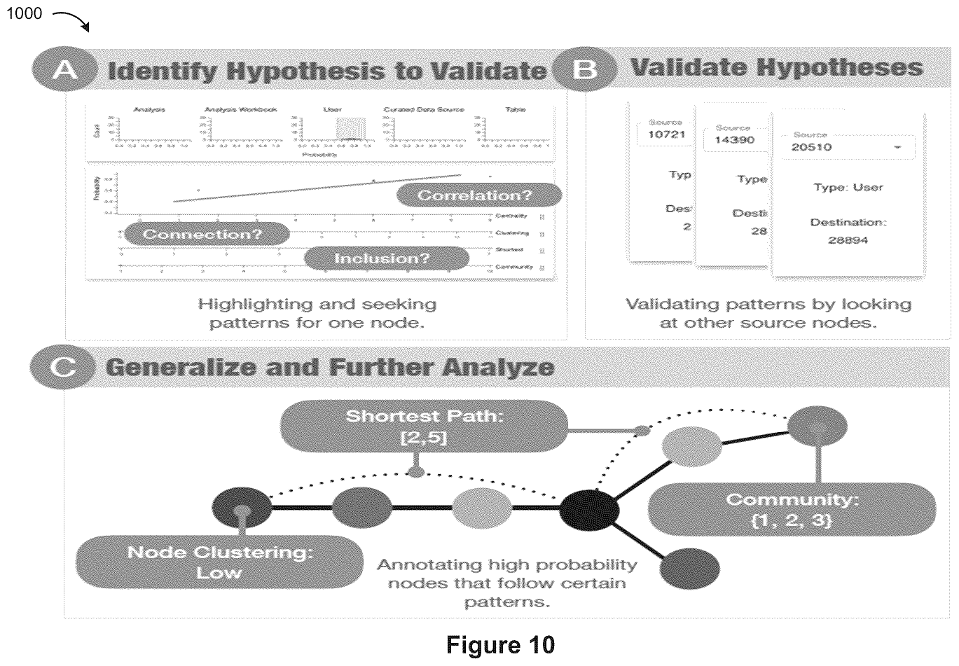

FIG. 10 shows an overview of another example usage scenario 1000, according to some implementations. A user may identify a hypothesis to validate (e.g., step A, highlighting and seeking patterns for one node). The user may then validate the hypothesis (e.g., step B, validating patterns by looking at other nodes). The user may also generalize and/or further analyze (e.g., step C, annotating high probability nodes that follow certain patterns). This scenario corresponds to trends for different input nodes. Suppose a data scientist named Jack is interested in summarizing and validating user recommendations by finding trends and patterns within those recommendations. He selects a user node in the data panel and notices that other users are recommended with a high probability. He brushes over the probability histogram that corresponds to the user node type. Within Jack's data, two users connected by a link suggests that each of their respective content would be of interest to one another.

Since the multi-axis scatterplot has the centrality attribute as the default main axis against which the probability is plotted, Jack sees that the probability for the user recommendations correlates with the centrality feature. This means that the more connections the target nodes have to other users or assets, the higher the chance they will be recommended to the user Jack selected to analyze. In addition, by looking at the axes that are not in focus, Jack also observes that all the user recommendations are part of the same community (community 1), the shortest path to the input node is 4 for all the user recommendations, and the recommendations exhibit low node clustering coefficients.

Jack hypothesizes that the GNN is recommending users to other users when it detects the following patterns: user nodes are within community 1 and a few hops away from the source node, and they have high centrality but low clustering. Thus, Jack repeats the process with an extensive selection of other user source nodes to verify his hypothesis.

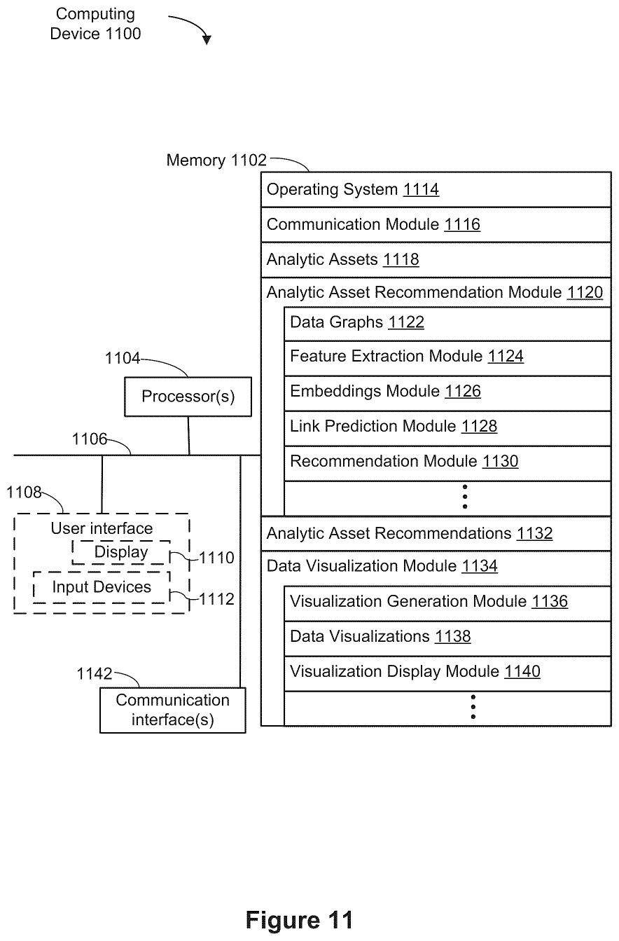

FIG. 11 is a block diagram of an example computing device 1100 for generating and/or visualizing recommendations for data analytic assets, according to some implementations. The computing device 1100 may host one or more databases that include data sources 102 or may provide various executable applications or modules. The computing device 1100, which may be a server, typically includes one or more processing units/cores (e.g., CPUs, GPUs, ASICs) 1104, one or more communication network interfaces 1142, memory 1102, and one or more communication buses 1106 for interconnecting these components. In some implementations, the computing device 1100 includes a user interface 1108, which includes a display 1110 and one or more input devices 1112 (e.g., a keyboard, a tough interface, a mouse). In some implementations, the communication buses 1106 include circuitry (sometimes called a chipset) that interconnects and controls communications between system components.

In some implementations, the memory 1102 includes high-speed random-access memory, such as DRAM, SRAM, DDR RAM, or other random-access solid-state memory devices, and may include non-volatile memory, such as one or more magnetic disk storage devices, optical disk storage devices, flash memory devices, or other non-volatile solid-state storage devices. In some implementations, the memory 1102 includes one or more storage devices remotely located from the processors 1104. The memory 1102, or alternatively the non-volatile memory devices within the memory 1102, comprises a non-transitory computer readable storage medium.

In some implementations, the memory 1102, or the computer readable storage medium of the memory 1102, stores the following programs, modules, and data structures, or a subset thereof:
an operating system 1114, which includes procedures for handling various basic system services and for performing hardware dependent tasks;
a network communication module 1116, which is used for connecting the computing device 1100 to other computers via the one or more communication network interfaces 1142 (wired or wireless) and one or more communication networks, such as the Internet, other wide area networks, local area networks, metropolitan area networks, and so on;
analytic assets 1118, which may include databases, tables, and/or analysis workbooks. Some implementations also store metadata for the analytic assets as part of, or in addition to, the analytic assets 1118. The metadata may include types of assets (e.g., database, table, or analysis workbook), authors (e.g., end user details), and/or creation data (e.g., analytic asset data or content) for the analytic assets;
an analytic asset recommendation module 1120 that includes data graphs 1122 (e.g., the data graph 300, FIG. 3), a feature extraction module 1124, an embeddings module 1126, a link prediction module 1128, and/or a recommendation module 1130, and/or other modules and data structures for recommending analytic assets;
analytic asset recommendations 1132 generated by the analytic asset recommendation module 1120; and/or
a data visualization module 1134 that includes a visualization generation module 1136, data visualizations 1138, a visualization display module 1140, and/or other modules and data structures for visualizing recommendations of data analytic assets. In some implementations, the data visualization module 1134 stores visual specifications, which are used to build data visualizations.

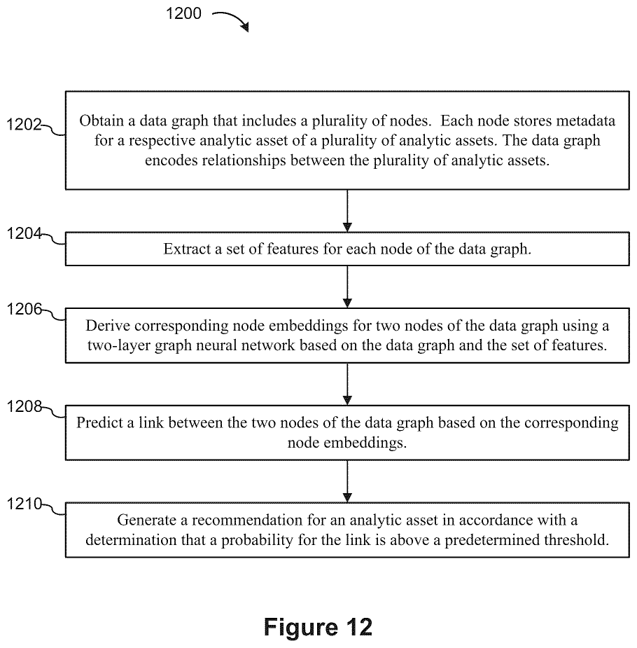

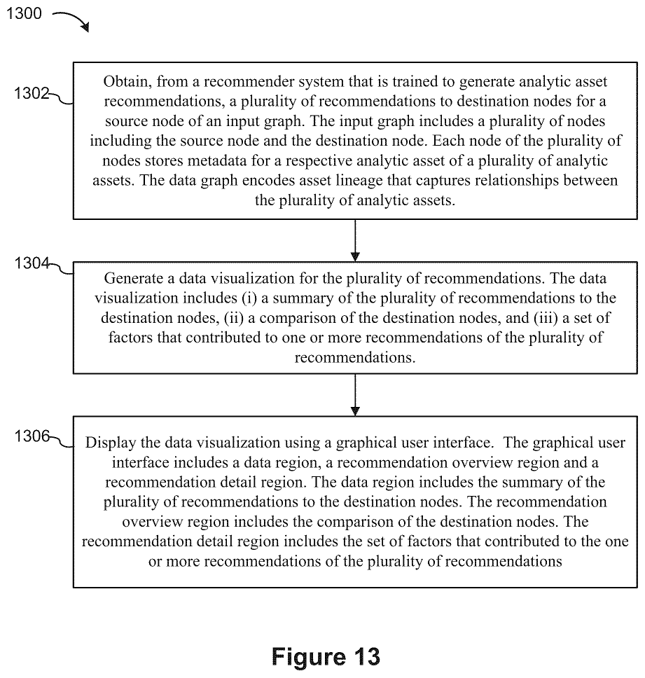

FIG. 11 is intended more as a functional description of the various features that may be present rather than as a structural schematic of the implementations described herein. In practice, and as recognized by those of ordinary skill in the art, items shown separately could be combined and some items could be separated. Details of the programs, modules, and data structures are described below in reference to the flowcharts in FIG. 12 and/or FIG. 13, according to some implementations.

FIG. 12 is a flowchart of an example method 1200 for generating analytic asset recommendations using graph neural networks, according to some implementations. The method is performed at a computing system (e.g., the computing device 1100) having one or more processors (e.g., the processors 1104) and memory (e.g., the memory 1102) storing one or more programs configured for execution by the one or more processors.

The method includes obtaining (1202) a data graph (e.g., the data graphs 1122) that includes a plurality of nodes. Each node stores metadata for a respective analytic asset of a plurality of analytic assets (e.g., the analytic assets 1118). The data graph encodes relationships (e.g., the edges shown in FIG. 3) between the plurality of analytic assets. In some implementations, the plurality of analytic assets includes an asset type, asset authors, and creation data (sometimes referred to as metadata for the analytic assets). In some implementations, the asset type includes one or more databases, tables, and/or analysis workbooks. In some implementations, the asset authors include end-user details. In some implementations, the data graph includes a node for a dataset that has a lineage relationship with a node for an analysis workbook. In some implementations, the data graph includes a node for a curated data source for telemetry and usage data that identify when and by whom analytic assets were created and viewed, respectively. In some implementations, the data graph includes one or more nodes for data sources for producing personalized recommendations. In some implementations, the plurality of nodes includes a node for database, a node for table, a node for curated data source, a node for user, a node for analysis workbook, and a node for analysis. In some implementations, the data graph includes connections between (i) a node for database and a node for table, (ii) the node for table and a node for user, (iii) the node for table and a node for curated data source, (iv) the node for table and a node for analysis workbook, (v) the node for curated data source and the node for analysis workbook, (vi) the node for user and the node for analysis workbook, and (vii) the node for analysis workbook and a node for analysis.

The method also includes extracting (1204) (e.g., by the feature extraction module 1124) a set of features for each node of the data graph. In some implementations, the set of features include asset type, community clustering, centrality and node degree.

The method also includes deriving (1206) (e.g., by the embedding module 1126) corresponding node embeddings for two nodes of the data graph using a two-layer graph neural network based on the data graph and the set of features. In some implementations, the two-layer graph neural network includes two layers that are each a GraphSAGE convolution. Instead of, or in addition to GraphSAGE, a similar framework for inductive representation learning on large graphs may be used in some implementations. In some implementations, the two-layer graph neural network is trained by batch training over ten epochs. In some implementations, each batch samples only direct neighbors and one random node for each node.

The method also includes predicting (1208) (e.g., by the link prediction module 1128) a link between the two nodes of the data graph based on the corresponding node embeddings.

The method also includes generating (1210) (e.g., by the recommendation module 1130) a recommendation (e.g., the analytic asset recommendations 1132) for an analytic asset in accordance with a determination that a probability for the link is above a predetermined threshold. In some implementations, each analytic asset type is associated with a corresponding predetermined threshold, and the method further includes generating the recommendation in accordance with a determination that a corresponding probability for a node is above its corresponding predetermined threshold.

FIG. 13 is a flowchart of an example method 1300 for generating data visualizations for interactive recommender systems for analytic assets, according to some implementations. The method is performed at a computing system (e.g., the computing device 1100) having one or more processors (e.g., the processors 1104) and memory (e.g., the memory 1102) storing one or more programs configured for execution by the one or more processors.

The method includes obtaining (1302) (e.g., by the data visualization module 1134), from a recommender system (e.g., the analytic asset recommendation module 1120) that is trained to generate analytic asset recommendations, a plurality of recommendations (e.g., the analytic asset recommendations 1132) to destination nodes for a source node of an input graph (e.g., the data graph 300, FIG. 3). The input graph includes a plurality of nodes including the source node and the destination node. Each node of the plurality of nodes stores metadata (e.g., asset type, asset authors, and creation data) for a respective analytic asset of a plurality of analytic assets. The data graph encodes asset lineage that captures relationships between the plurality of analytic assets.

The method also includes generating (1304) (e.g., by the visualization generation module 1136) a data visualization (e.g., the data visualizations 1138) for the plurality of recommendations. The data visualization includes (i) a summary of the plurality of recommendations to the destination nodes, (ii) a comparison of the destination nodes, and (iii) a set of factors that contributed to one or more recommendations of the plurality of recommendations.

The method also includes displaying (1306) (e.g., by the visualization display module 1140) the data visualization using a graphical user interface. The graphical user interface includes a data region, a recommendation overview region and a recommendation detail region. The data region includes the summary of the plurality of recommendations to the destination nodes, the recommendation overview region includes the comparison of the destination nodes, and the recommendation detail region includes the set of factors that contributed to the one or more recommendations of the plurality of recommendations. In some implementations, the recommendation overview region comprises (i) a probability distribution region based on node type, and (ii) a recommendation attribute region that provides further details of the relationship between the probabilities and attributes from the input graph. Recommendation probability coordinates views in the two regions, thereby helping a user to compare recommendations. Examples of graphical user interfaces are described above in reference to FIGS. 1, 4-10, according to some implementations.

In some implementations, the recommendation overview region includes a probability histogram view and a multi-axis scatter plot view. In some implementations, the probability histogram view displays recommendation probability distributions according to asset types. The probability distributions allows users to evaluate a model's confidence with respect to recommending an asset type. In some implementations, the asset types are modifiable and quantifiable for different domains. In some implementations, the multi-axis scatter plot view displays bivariate relationships between recommendation probabilities and different node features and graph attributes. In some implementations, y-axis for the multi-axis scatter plot view remains fixed, and x-axis for the multi-axis scatter plot view is modifiable through a drag-and-drop interaction. In some implementations, a change in the x-axis allows users to visually assess distribution of probabilities across different asset types as well as features and attributes. In some implementations, the recommendation detail region comprises two adjacent views including a wrapped two-dimensional array and an embedding projection that allow users to inspect recommendations they selected in other components of the graphical user interface and analyze them in more detail. In some implementations, the wrapped two-dimensional array display probability and feature as a row set, each row set corresponding to one recommendation and comprising a recommendation probability in a top row and feature in a bottom row. In some implementations, the embedding projection projects node embeddings produced by a graph neural network into a two dimensional space using a Uniform Manifold Approximation and Projection (UMAP). In some implementations, the embedding projection uses shape to differentiate between the source node and the destination nodes. In some implementations, points in the embedding projection are colored according to asset type. In some implementations, the embedding projection represents a multivariate summary of the data that allow users to contextualize recommendations by using the distance between points as a proxy for similarity for nodes. In some implementations, the recommendation detail region recasts data shown in the recommendation overview region using a different visual encoding.

In some implementations, the method further includes selecting the plurality of recommendations from a representative sample obtained from a range of recommendation probabilities for the source node, based on a size of the input graph.

In some implementations, the method further includes displaying, in the data region, prediction probabilities for the plurality of recommendations. In some implementations, the method further includes, in response to detecting a user input in the data region, recording a prediction quality for one or more recommendations. In some implementations, the method further includes displaying, in the data region, features and/or properties of the destination nodes. In some implementations, the method further includes: displaying, in the data region, a node selection widget and a table view; in response to a user input via the node selection widget, selecting the source node from the input graph and displaying basic properties of the source node; and displaying, in the table view, the destination nodes of predicted links. In some implementations, the method further includes displaying, in the table view, derived properties of the input graph including information shortest path between two nodes and communities within the input graph. In some implementations, the derived properties include centrality attributes for nodes of the input graph and graph attributes derived from relationship between multiple nodes including shortest path and community information. In some implementations, the comparison includes predictive probabilities and node properties for the destination nodes. In some implementations, the comparison includes relationships between distributions of prediction probabilities and path length between the source node and the destination nodes.

The terminology used in the description of the invention herein is for the purpose of describing particular implementations only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The foregoing description, for purpose of explanation, has been described with reference to specific implementations. However, the illustrative discussions above are not intended to be exhaustive or to limit the invention to the precise forms disclosed. Many modifications and variations are possible in view of the above teachings. The implementations were chosen and described in order to best explain the principles of the invention and its practical applications, to thereby enable others skilled in the art to best utilize the invention and various implementations with various modifications as are suited to the particular use contemplated.

What is claimed is:

1. A method of generating data visualizations for interactive recommender systems for analytic assets, the method comprising:
obtaining, from a recommender system that is trained to generate analytic asset recommendations, a plurality of recommendations to destination nodes for a source node of an input graph, wherein the input graph includes a plurality of nodes including the source node and the destination node, wherein each node of the plurality of nodes stores metadata for a respective analytic asset of a plurality of analytic assets, and wherein the input graph encodes asset lineage that captures relationships between the plurality of analytic assets;
generating a data visualization for the plurality of recommendations, wherein the data visualization includes (i) a summary of the plurality of recommendations to the destination nodes, (ii) a comparison of the destination nodes, and (iii) a set of factors that contributed to one or more recommendations of the plurality of recommendations; and
displaying the data visualization using a graphical user interface, wherein the graphical user interface includes a data region, a recommendation overview region and a recommendation detail region, wherein (i) the data region includes the summary of the plurality of recommendations to the destination nodes, (ii) the recommendation overview region includes the comparison of the destination nodes, and (iii) the recommendation detail region includes the set of factors that contributed to the one or more recommendations of the plurality of recommendations.

2. The method of claim 1, further comprising:
displaying, in the data region, prediction probabilities for the plurality of recommendations.

3. The method of claim 1, further comprising:
in response to detecting a user input in the data region, recording a prediction quality for one or more recommendations.

4. The method of claim 1, further comprising:
displaying, in the data region, features and/or properties of the destination nodes.

5. The method of claim 1, further comprising:
displaying, in the data region, a node selection widget and a table view;
in response to a user input via the node selection widget, selecting the source node from the input graph and displaying basic properties of the source node; and
displaying, in the table view, the destination nodes of predicted links.

6. The method of claim 5, further comprising:
displaying, in the table view, derived properties of the input graph including information shortest path between two nodes and communities within the input graph.

7. The method of claim 6, wherein the derived properties include centrality attributes for nodes of the input graph and graph attributes derived from relationship between multiple nodes including shortest path and community information.

8. The method of claim 1, wherein the comparison includes predictive probabilities and node properties for the destination nodes.

9. The method of claim 1, wherein the comparison includes relationships between distributions of prediction probabilities and path length between the source node and the destination nodes.

10. The method of claim 1, wherein the recommendation overview region comprises (i) a probability distribution region based on node type, and (ii) a recommendation attribute region that provides further details of relationship between probabilities and attributes from the input graph, wherein recommendation probability coordinates views in the probability distribution region and the recommendation attribute region, thereby helping a user to compare recommendations.

11. The method of claim 1, further comprising:
selecting the plurality of recommendations from a representative sample obtained from a range of recommendation probabilities for the source node, based on a size of the input graph.

12. The method of claim 1, wherein the recommendation overview region comprises a probability histogram view and a multi-axis scatter plot view.

13. The method of claim 12, wherein the probability histogram view displays recommendation probability distributions according to asset types, wherein the recommendation probability distributions allows users to evaluate a model's confidence with respect to recommending an asset type.

14. The method of claim 12, wherein the multi-axis scatter plot view displays bivariate relationships between recommendation probabilities and different node features and graph attributes.

15. The method of claim 1, wherein the recommendation detail region comprises two adjacent views including a wrapped two-dimensional array and an embedding projection that allow users to inspect recommendations they selected in other components of the graphical user interface and analyze them in more detail.

16. The method of claim 15, wherein the wrapped two-dimensional array displays probability and feature as a row set, each row set corresponding to one recommendation and comprising a recommendation probability in a top row and feature in a bottom row.

17. The method of claim 15, wherein the embedding projection uses shape to differentiate between the source node and the destination nodes.

18. The method of claim 15, wherein the embedding projection represents a multivariate summary of data that allows users to contextualize recommendations by using distance between points as a proxy for similarity for nodes.

19. A computer system for visual analysis of datasets, comprising:
one or more processors; and
memory;
wherein the memory stores one or more programs configured for execution by the one or more processors, and the one or more programs comprising instructions for:
obtaining, from a recommender system that is trained to generate analytic asset recommendations, a plurality of recommendations to destination nodes for a source node of an input graph, wherein the input graph includes a plurality of nodes including the source node and the destination node, wherein each node of the plurality of nodes stores metadata for a respective analytic asset of a plurality of analytic assets, and wherein the input graph encodes asset lineage that captures relationships between the plurality of analytic assets;
generating a data visualization for the plurality of recommendations, wherein the data visualization includes (i) a summary of the plurality of recommendations to the destination nodes, (ii) a comparison of the destination nodes, and (iii) a set of factors that contributed to one or more recommendations of the plurality of recommendations; and
displaying the data visualization using a graphical user interface, wherein the graphical user interface includes a data region, a recommendation overview region and a recommendation detail region, wherein (i) the data region includes the summary of the plurality of recommendations to the destination nodes, (ii) the recommendation overview region includes the comparison of the destination nodes, and (iii) the recommendation detail region includes the set of factors that contributed to the one or more recommendations of the plurality of recommendations.

20. A non-transitory computer readable storage medium storing one or more programs configured for execution by a computer system having a display, one or more processors, and memory, the one or more programs comprising instructions for:
obtaining, from a recommender system that is trained to generate analytic asset recommendations, a plurality of recommendations to destination nodes for a source node of an input graph, wherein the input graph includes a plurality of nodes including the source node and the destination node, wherein each node of the plurality of nodes stores metadata for a respective analytic asset of a plurality of analytic assets, and wherein the input graph encodes asset lineage that captures relationships between the plurality of analytic assets;
generating a data visualization for the plurality of recommendations, wherein the data visualization includes (i) a summary of the plurality of recommendations to the destination nodes, (ii) a comparison of the destination nodes, and (iii) a set of factors that contributed to one or more recommendations of the plurality of recommendations; and
displaying the data visualization using a graphical user interface, wherein the graphical user interface includes a data region, a recommendation overview region and a recommendation detail region, wherein (i) the data region includes the summary of the plurality of recommendations to the destination nodes, (ii) the recommendation overview region includes the comparison of the destination nodes, and (iii) the recommendation detail region includes the set of factors that contributed to the one or more recommendations of the plurality of recommendations.
